(19) United States
(12) Patent Application Publication
(10) Pub. No.: US 2024/0092997 A1
(43) Pub. Date: Mar. 21, 2024

(54) ZINC OXIDE, RUBBER COMPOSITION FOR RUBBER-STEEL CORD COMPOSITES, AND PNEUMATIC TIRE

(71) Applicant: Toyo Tire Corporation, Itami-shi (JP)

(72) Inventors: Hama Nagai, Itami-shi (JP); Norio Minouchi, Itami-shi (JP)

(73) Assignee: Toyo Tire Corporation, Itami-shi (JP)

(21) Appl. No.: 18/234,520

(22) Filed: Aug. 16, 2023

(30) Foreign Application Priority Data
Sep. 21, 2022 (JP) 2022-150120

(51) Int. Cl. C08K 3/22; B60C 1/00; B60C 9/00; C08L 7/00

(52) U.S. Cl. CPC C08K 3/22; B60C 1/00; B60C 9/0007; C08L 7/00; B60C 2001/0066; B60C 2009/0021; C08K 2003/2296

(57) ABSTRACT

A rubber composition comprising a zinc oxide which comprises aluminum and iron. The zinc oxide's content of the iron is preferably 15 ppm or more and 100 ppm or less and the zinc oxide's content of the aluminum is 40 ppm or more and 100 ppm or less. The zinc oxide's ratio of a content of the iron to a content of the aluminum is preferably 0.2 to 2.3. The zinc oxide's content of the iron is preferably 15 ppm or more and 80 ppm or less. The rubber composition is used for rubber-steel cord composites.

### BACKGROUND OF THE INVENTION

### Field of the Invention

The present invention relates to zinc oxide, a rubber composition for rubber-steel cord composites, and a pneumatic tire.

### Description of the Related Art

A pneumatic tire is constituted from a vulcanized rubber and a metallic member such as a steel cord, and is required to offer various performances such as safety and low-fuel consumption. Particularly, a belt part that is a member constituting a pneumatic tire is required to improve adhesion between a steel cord and a vulcanized rubber (hereinafter also referred to as “topping rubber”) covering the steel cord, that is, to improve the peel force of a topping rubber. As a technique for improving the peel force of a topping rubber, addition of various compounding agents to a rubber composition as a raw material of a topping rubber is known.

Patent Document 1 mentioned below describes that a zinc oxide powder is synthesized by a method in which an aqueous solution containing a zinc salt is neutralized to obtain a precipitate such as a hydroxide and the precipitate is heated after filtration and drying (also referred to as “American process” or “wet process”) as zinc oxide for use as a raw material of a rubber composition.

### PRIOR ART DOCUMENT

### Patent Document

Patent Document 1: JP-A-2000-95519

### SUMMARY OF THE INVENTION

Patent Document 1 mentioned above is characterized by producing zinc oxide by a wet process, and there is no description about the properties of the zinc oxide.

The present inventors have focused on the metallic composition of zinc oxide to be added to a rubber composition as a raw material to improve the peel force of a topping rubber, and as a result have found that when zinc oxide having a specific metallic composition is added to a rubber composition, a vulcanized rubber of the rubber composition has significantly improved peel force from a metallic member such as a steel cord.

In view of the above circumstances, it is an object of the present invention to provide zinc oxide usable for a rubber composition as a raw material of a vulcanized rubber having improved peel force from a metallic member such as a steel cord, a rubber composition for rubber-steel cord composites containing the zinc oxide, and a pneumatic tire containing a vulcanized rubber of the rubber composition.

The above object can be achieved by the following configurations. Specifically, the present invention relates to zinc oxide (1) containing aluminum and iron.

The zinc oxide (1) is preferably zinc oxide (2) whose content of the iron is 15 ppm or more and 100 ppm or less and whose content of the aluminum is 40 ppm or more and 100 ppm or less.

The zinc oxide (1) or (2) is preferably zinc oxide (3) whose ratio of a content of the iron to a content of the aluminum is 0.2 to 2.3.

Any one of the zinc oxides (1) to (3) is preferably zinc oxide (4) whose content of the iron is 15 ppm or more and 80 ppm or less.

The present invention also relates to a rubber composition containing any one of the zinc oxides (1) to (4) or a rubber composition for rubber-steel cord composites containing any one of the zinc oxides (1) to (4)

The present invention also relates to a pneumatic tire containing a vulcanized rubber of the rubber composition or a pneumatic tire containing a vulcanized rubber of the rubber composition for rubber-steel cord composites.

As far as the present inventors are aware, there is no technique in which the composition of metals contained in zinc oxide is examined in detail. Under the circumstances, the present inventors have intensively studied, and as a result have found that when zinc oxide having a specific metallic composition, specifically zinc oxide containing aluminum and iron is added to a rubber composition, a vulcanized rubber of the rubber composition has improved peel force from a metallic member such as a steel cord. Particularly, the present inventors have found that when zinc oxide whose iron content is 15 ppm or more and 100 ppm or less and whose aluminum content is 40 ppm or more and 100 ppm or less or zinc oxide whose ratio of an iron content to an aluminum content is 0.2 to 2.3 is added to a rubber composition, a vulcanized rubber of the rubber composition has further improved peel force from a metallic member such as a steel cord.

It should be noted that a pneumatic tire is used for a long time period, and therefore as for the peel force from a metallic member such as a steel cord, a vulcanized rubber (topping rubber) needs to be improved not only in peel force just after production (hereinafter also referred to as “initial peel force”) but also in peel force after a lapse of long time from production (peel force after a deterioration test corresponding to such peel force is also referred to as “moist heat peel force”). In the present invention, the zinc oxide whose iron content is 15 ppm or more and 80 ppm or less is particularly preferably added to a rubber composition, which improves not only the initial peel force but also the moist heat peel force.

A vulcanized rubber of a rubber composition containing the zinc oxide according to the present invention is excellent in peel force from a metallic member such as a steel cord. Therefore, the zinc oxide according to the present invention can suitably be used for a rubber composition for pneumatic tires, particularly a rubber composition for rubber-steel cord composites.

### DETAILED DESCRIPTION OF THE PREFERRED EMBODIMENTS

Zinc oxide according to the present invention is preferably powdery zinc oxide (zinc oxide powder), and the specific surface area of the powdery zinc oxide is preferably 2 to 10 [m²/g], more preferably 2 to 6 [m²/g]. The specific surface area of the zinc oxide powder according to the present invention can be measured by, for example, the BET method (JIS R1626).

As described above, the American process (wet process) is known as a method for producing zinc oxide. However, as a method other than that, the French process is known. The French process is a method in which metallic zinc is evaporated by heating and zinc vapor is oxidized to obtain a zinc oxide powder. A metallic zinc source as a raw material can be selected from various options such as distilled zinc, electrolytic zinc, and recycle zinc, and examples of recycle zinc include zinc dross, oxidized ash, and electric furnace dust. The zinc oxide according to the present invention is preferably a zinc oxide powder obtained by the French process in which zinc dross is evaporated by heating and zinc vapor is oxidized.

The zinc oxide according to the present invention contains aluminum and iron. The zinc oxide according to the present invention is particularly preferably zinc oxide (i) whose iron content is 15 ppm or more and 100 ppm or less and whose aluminum content is 40 ppm or more and 100 ppm or less or zinc oxide (ii) whose ratio of an iron content to an aluminum content is 0.2 to 2.3 because when such zinc oxide is added to a rubber composition, a vulcanized rubber of the rubber composition is more excellent in peel force from a metallic member such as a steel cord. The reason why a vulcanized rubber of a rubber composition containing the zinc oxide (i) or (ii), particularly the zinc oxide (ii) is excellent in peel force from a metallic member such as a steel cord is not clear, but it is expected that when trace amounts of aluminum and iron are present in a vulcanized rubber, an adhesive membrane (adhesive interface) formed between the vulcanized rubber and the metallic member becomes complicated so that the peel force improves due to so-called anchor effect.

Further, the zinc oxide according to the present invention is particularly preferably zinc oxide (iii) whose iron content is 15 ppm or more and 80 ppm or less because such zinc oxide is added to a rubber composition, a vulcanized rubber of the rubber composition is excellent not only in initial peel force but also in moist heat peel force from a metallic member such as a steel cord. The reason why a vulcanized rubber of a rubber composition containing the zinc oxide (iii) is significantly excellent in moist heat peel force from a metallic member such as a steel cord is not clear, but it is expected that when the zinc oxide is designed to have an iron content of 15 ppm or more and 80 ppm or less, the influence of oxidation degradation of iron is prevented while the anchor effect of the vulcanized rubber on the metallic member is achieved so that the moist heat peel force of the vulcanized rubber from the metallic member can be maintained and improved.

When the zinc oxide according to the present invention is added to a rubber composition, particularly a rubber composition for rubber-steel cord composites, the amount of the zinc oxide to be added is preferably 1 to 15 parts by mass, more preferably 3 to 10 parts by mass per 100 parts by mass of the total amount of a rubber component.

The zinc oxide according to the present invention can suitably be used for a rubber composition, particularly a rubber composition for rubber-steel cord composites. Hereinafter, materials (other than zinc oxide) constituting a rubber composition, particularly a rubber composition for rubber-steel cord composites according to the present invention will be described.

The rubber composition, particularly the rubber composition for rubber-steel cord composites according to the present invention contains a rubber component. As the rubber component, for example, a diene-based rubber is preferred. Examples of the diene-based rubber include, but are not limited to, natural rubber (NR), isoprene rubber (IR), butadiene rubber (BR), styrene-butadiene rubber (SBR), acrylonitrile-butadiene rubber (NBR), chloroprene rubber (CR), styrene-isoprene copolymer rubber, a butadiene-isoprene copolymer, and styrene-isoprene-butadiene copolymer rubber. These butadiene-based rubbers may be used singly or in combination of two or more of them.

The rubber composition, particularly the rubber composition for rubber-steel cord composites according to the present invention may contain carbon black and/or silica as a filler, a vulcanizing agent, a vulcanization accelerator, an antiaging agent, stearic acid, a softener such as wax or oil, a processing aid, and others.

As the reinforcing filler, carbon black and/or silica are/is preferably used. That is, the reinforcing filler may be carbon black alone, silica alone, or a combination of carbon black and silica. It is preferred that carbon black is used alone or carbon black and silica are used in combination. The content of the reinforcing filler is not limited and is, for example, preferably 10 to 140 parts by mass, more preferably 20 to 100 parts by mass, even more preferably 30 to 80 parts by mass per 100 parts by mass of the total amount of a rubber component.

Examples of the carbon black that can be used include: carbon blacks usually used in the rubber industry, such as SAF, ISAF, HAF, FEF, and GPF; and conductive carbon blacks such as acetylene black and ketjen black. Examples of the silica to be used include silicas usually used for rubber reinforcement, such as wet silica, dry silica, sol-gel silica, and surface-treated silica. Among them, wet silica is preferred.

When silica is contained as a filler, a silane coupling agent is also preferably contained. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl)tetrasulfide (e.g., “Si69” manufactured by Degussa), bis(3-triethoxysilylpropyl)disulfide (e.g., “Si75” manufactured by Degussa), bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane.

As the vulcanizing agent, sulfur can suitably be used. The sulfur may be ordinary sulfur for rubber, and sulfur such as powdered sulfur, precipitated sulfur, insoluble sulfur, and highly dispersible sulfur can be used. The content of the vulcanizing agent in the rubber composition, particularly the rubber composition for rubber-steel cord composites according to the present invention is preferably 3 to 10 parts by mass per 100 parts by mass of the total amount of a rubber component.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination of two or more of them.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them.

The rubber composition, particularly the rubber composition for rubber-steel cord composites according to the present invention is obtained by kneading not only the zinc oxide, the rubber component, the filler, the vulcanizing agent, and the vulcanization accelerator but also the antiaging agent, stearic acid, the softener such as wax or oil, the processing aid, and others using a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a vulcanizing agent and a vulcanization accelerator are previously kneaded to prepare a master batch, the remaining components are added to the master batch, and the resultant is further kneaded, a method in which components are added in any order and kneaded, and a method in which all the components are added at the same time and kneaded.

A vulcanized rubber of a rubber composition containing the zinc oxide according to the present invention is excellent in peel force from a metallic member such as a steel cord. Therefore, the rubber composition or the rubber composition for rubber-steel cord composites according to the present invention can suitably be used for a belt part constituting a pneumatic tire.

### Examples

The present invention will more specifically be described below with reference to examples.

### (Preparation of Zinc Oxides 1 to 4)

Zinc dross was heated at 950° C. to generate zinc vapor, and the zinc vapor was oxidized and burned by blowing air thereinto to generate zinc oxide. The generated zinc oxide was cooled and then collected to obtain a zinc oxide powder. On the other hand, as zinc oxide 1, a commercially-available product (“Zinc oxide grade 3” manufactured by MITSUI MINING & SMELTING CO., LTD.) was used. The contents of iron (Fe) and aluminum (Al) in each of the zinc oxides 1 to 4 were measured by inductively coupled plasma optical emission spectrometry (ICP-OES) using “Optima 8300” manufactured by PerkinElmer. The results are shown in Table 1. It should be noted that “N.D” shown in Table 1 means that the content is below the detection limit.

TABLE 1

| | Comparative | | | |
|---|---|---|---|---|
| | Example 1 | Example 1 | Example 2 | Example 3 |
| | Zinc oxide 1 | Zinc oxide 2 | Zinc oxide 3 | Zinc oxide 4 |
| Fe (ppm) | N.D | 19.30 | 52.43 | 82.39 |
| Al (ppm) | 0.61 | 52.28 | 95.11 | 90.74 |
| Fe/Al ratio | 0.00 | 0.37 | 0.55 | 0.91 |

### (Preparation of Rubber Compositions for Rubber-Steel Cord Composites)

A rubber composition of each of Examples 4 to 6 and Comparative Example 2 was prepared by blending compounding agents with 100 parts by mass of a rubber component in accordance with the formulation shown in Table 2 and kneading the resultant using an ordinary Banbury mixer. The compounding agents shown in Table 2 are as follows.
Natural rubber (NR): RSS #3
Carbon black: trade name “Seast 300”, manufactured by TOKAI CARBON CO., LTD.
Stearic acid: trade name “Beads Stearic Acid”, manufactured by NOF CORPORATION
Antiaging agent: trade name: “Santoflex 6PPD”, manufactured by FLEXSYS
Cobalt stearate: trade name: “Cobalt Stearate”, manufactured by Japan Energy Corporation.
Melamine derivative (hexamethoxymethylmelamine): trade name: “CYREZ 963L”, manufactured by Mitsui Cytec Ltd.
Resorcin-based compound (resorcin-alkylphenol-formalin resin): trade name: “SUMIKANOL 620”, manufactured by SUMITOMO CHEMICAL COMPANY, LIMITED
Sulfur: trade name “MUCRON OT-20”, manufactured by SHIKOKU CHEMICALS CORPORATION
Vulcanization accelerator: trade name “NOCCELER DZ-G”, manufactured by OUCHI SHINKO CHEMICAL INDUSTRIAL CO., LTD.

The initial peel force and the moist heat peel force were evaluated using the rubber compositions of Examples 4 to 6 and Comparative Example 2 obtained above. Specifically, steel cords for belt (3×0.20+6×0.35 mm structure, copper/zinc=64/36 (mass ratio), amount of brass plating deposited 5 g/kg) were arranged in parallel at a density of 12/25 mm, and both surfaces of the resultant were covered with a 1 mm-thick rubber sheet made of each of the rubber compositions. Two layers obtained in such a manner as described above were laminated so that the cords were in parallel with each other to prepare an unvulcanized sample for peel adhesion test. The initial peel force and the moist heat peel force were evaluated using the obtained unvulcanized sample under the following conditions.

### (Initial Peel Force)

An unvulcanized sample of each of the rubber compositions of Examples 4 to 6 and Comparative Example 2 obtained above was prepared and then vulcanized under conditions of 150° C. and 30 minutes. The vulcanized test piece was subjected to a peel adhesion test using Autograph “DCS500” manufactured by SHIMADZU CORPORATION, and a maximum strength at the time of peeling was measured as the initial peel force. The initial peel force is expressed as an index number determined by taking the peel force of Comparative Example 2 as 100. The larger index number indicates that the initial peel force is more excellent and adhesiveness is more excellent. The results are shown in Table 2.

### (Moist Heat Peel Force)

An unvulcanized sample of each of the rubber compositions of Examples 4 to 6 and Comparative Example 2 obtained above was prepared and then vulcanized under conditions of 150° C. and 30 minutes. The vulcanized test piece was left to stand in saturated vapor at 105° C. for 96 hours and then subjected to a peeling test between two steel-cord layers using Autograph “DCS500” manufactured by SHIMADZU CORPORATION, and a maximum strength until breakage was measured as the moist heat peel force. The moist heat peel force is expressed as an index number determined by taking the moist heat peel force of Comparative Example 2 as 100. The larger index number indicates that the moist heat peel force is more excellent and moist heat adhesiveness is more excellent. The results are shown in Table 2.

TABLE 2

| | Comparative | | | |
|---|---|---|---|---|
| | Exam- | Exam- | Exam- | Exam- |
| | ple 2 | ple 4 | ple 5 | ple 6 |
| NR | 100 | 100 | 100 | 100 |
| Carbon black | 60 | 60 | 60 | 60 |
| Zinc oxide 1 | 8 | | | |
| Zinc oxide 2 | | 8 | | |
| Zinc oxide 3 | | | 8 | |
| Zinc oxide 4 | | | | 8 |
| Stearic acid | 1 | 1 | 1 | 1 |
| Antiaging agent | 2 | 2 | 2 | 2 |
| Cobalt stearate | 2 | 2 | 2 | 2 |
| Melamine derivative | 2 | 2 | 2 | 2 |
| Resorcin-based compound | 2 | 2 | 2 | 2 |
| Sulfur | 6 | 6 | 6 | 6 |
| Vulcanization accelerator | 1 | 1 | 1 | 1 |
| Initial peel force | 100 | 108 | 110 | 107 |
| Moist heat peel force | 100 | 102 | 101 | 96 |

As can be seen from Table 2, all the vulcanized rubbers of the rubber compositions for rubber-steel cord composites according to Examples 4 to 6 are excellent in initial peel force. Particularly, it can be seen that the vulcanized rubbers of the rubber compositions for rubber-steel cord composites according to Examples 4 and 5 contain zinc oxide whose iron content is 15 ppm or more and 80 ppm or less, and therefore have improved not only in initial peel force but also in moist heat peel force.

What is claimed is:

1. A rubber composition comprising a zinc oxide which comprises aluminum and iron.

2. The rubber composition according to claim 1,
wherein the zinc oxide's content of the iron is 15 ppm or more and 100 ppm or less and the zinc oxide's content of the aluminum is 40 ppm or more and 100 ppm or less.

3. The rubber composition according to claim 1,
wherein the zinc oxide's ratio of a content of the iron to a content of the aluminum is 0.2 to 2.3.

4. The rubber composition according to claim 1,
wherein the zinc oxide's content of the iron is 15 ppm or more and 80 ppm or less.

5. A rubber composition for rubber-steel cord composites comprising a zinc oxide which comprises aluminum and iron.

6. The rubber composition for rubber-steel cord composites according to claim 5,
wherein the zinc oxide's content of the iron is 15 ppm or more and 100 ppm or less and the zinc oxide's content of the aluminum is 40 ppm or more and 100 ppm or less.

7. The rubber composition for rubber-steel cord composites according to claim 5,
wherein the zinc oxide's ratio of a content of the iron to a content of the aluminum is 0.2 to 2.3.

8. The rubber composition for rubber-steel cord composites according to claim 5,
wherein the zinc oxide's content of the iron is 15 ppm or more and 80 ppm or less.

9. A pneumatic tire comprising a vulcanized rubber of the rubber composition according to claim 1.

10. A pneumatic tire comprising a vulcanized rubber of the rubber composition for rubber-steel cord composites according to claim 5.
